(19) United States
(12) Patent Application Publication
(10) Pub. No.: US 2021/0232438 A1
(43) Pub. Date: Jul. 29, 2021

(54) SERVERLESS LIFECYCLE MANAGEMENT DISPATCHER

(71) Applicant: Telefonaktiebolaget LM Ericsson (publ), Stockholm (SE)

(72) Inventors: Miljenko OPSENICA, Espoo (FI); Timo SIMANAINEN, Veikkola (FI)

(73) Assignee: Telefonaktiebolaget LM Ericsson (publ), Stockholm (SE)

(21) Appl. No.: 15/733,854

(22) PCT Filed: May 30, 2018
(86) PCT No.: PCT/EP2018/064300

§ 371 Date: Nov. 30, 2020

(51) Int. Cl. G06F 9/50; G06F 9/48; G06F 9/455

(52) U.S. Cl. CPC G06F 9/5083; G06F 9/4881; G06F 2009/4557; G06F 2009/45595; G06F 9/45558

(57) ABSTRACT

A method, in a serverless life-cycle management, (LCM) dispatcher, and an associated serverless LCM dispatcher for implementing a workload in a virtualization network. The method comprises receiving a workload trigger comprising an indication of a first workload, obtaining a description of the first workload from a workload description database based on the indication of the first workload, categorising, based on the description and the workload trigger, the first workload as a non LCM workload capable of being implemented with no LCM routines, or an LCM workload capable of being implemented using LCM routines. Furthermore, responsive to categorising the first workload as an LCM workload, the method comprises determining a LCM capability level for implementing the first workload, identifying an LCM component capable of providing the LCM capability level, and transmitting an implementation request to the LCM component to implement the first workload.

### TECHNICAL FIELD

Embodiments disclosed herein relate to the implementation of a workload in a virtualisation network. In particular the implementation of a workload using a serverless lifecycle management (LCM) dispatcher.

### BACKGROUND

An aim for every industry is to reduce cost and increase profit. In this regard, many industries have been moving towards a higher level of virtualization and automation to reduce the resources required. Virtualization and optimization of resource usage has been evolving to use more granular computing units where some processing may not even need dedicated servers. This evolution has provided opportunities for using different virtualization models for different purposes. For example, depending on the virtualized function and corresponding requirements, a virtual machine, container or even stateless function may be used to implement the function without dedicated servers to fulfil targeted workloads.

Considering Key Performance Indicators (KPIs), heavy functions with a longer lifetime and/or more complex dependencies may still be better and cheaper to run using heavier computing units such as containers or virtual machines. At the same time, lighter functions (for example, a function as a service (FaaS) function) may be run by a serverless framework without dedicated servers. The latter type of function may be particularly useful in the constrained edge cloud where there may be more strict limitations on the total computing power. Related constraints may directly limit the functions run in such environments where a limitations matrix can also include limitations on power supply and connectivity. The complexity of functionality may directly impact the demand on used resources. Therefore, simplification of functions and more selective granular usage may help in the optimization of used resources.

With the exponential increase of newly offered functions/services and used virtualization technologies, there are continuous growing challenges in the related orchestration and lifecycle management of such heterogenic resource pools. Growing number of devices, such as in Internet of Things (IoT) use cases, may additionally add to the shortage of the cloud resources.

Recent industry trends to use serverless frameworks partly address these resource limitations. In the serverless frameworks, computing tasks are intentionally split to a smaller, preferably stateless, tasks that may be performed on demand seamlessly in the background. In this way, selective, more granular, resources may be used for shorter periods of time and the total resource pool may therefore be made available to other functions. The majority of such implementations referred to as Function as a Service (FaaS) are targeting http based traffic often originating from web based applications. However, these solutions are isolated proprietary frameworks and do not answer wide computing use cases. These solutions also do not consider hybrid cases either, where containers and virtual machines might comprise a mash up of the FaaS functions or more complex FaaS topologies with more dependencies in-between the functions.

Current FaaS computing solutions are limited to isolated proprietary frameworks targeting mostly http traffic processing and relatively simple FaaS topologies with limited function dependencies handling. Those solutions have very limited lifecycle management with the simple deployment and un-deployment routines. There is therefore a need for an orchestration solution which can support growing number of industry use cases targeting distributed computing with a more complex mash up matrix of functionality and including hybrid virtualization technologies.

### SUMMARY

According to some embodiments there is provided a method, in a serverless life-cycle management, LCM, dispatcher, for implementing a workload in a virtualization network. The method comprises receiving a workload trigger comprising an indication of a first workload, obtaining a description of the first workload from a workload description database based on the indication of the first workload; categorising, based on the description and the workload trigger, the first workload as a non LCM workload capable of being implemented with no LCM routines, or an LCM workload capable of being implemented using LCM routines; and responsive to categorising the first workload as an LCM workload, determining, a LCM capability level for implementing the first workload, identifying an LCM component capable of providing the LCM capability level; and transmitting an implementation request to the LCM component to implement the first workload.

According to some embodiments of the present invention there is provided a serverless life-cycle management, LCM, dispatcher for implementing a workload in a virtualization network. The serverless LCM dispatcher comprises processing circuitry configured to: receive a workload trigger comprising an indication of a first workload and obtain a description of the first workload from a workload description database based on the indication of the first workload; categorise, based on the description and the workload trigger, the first workload as a non LCM workload capable of being implemented with no LCM routines, or an LCM workload capable of being implemented using LCM routines; and responsive to categorising the first workload as an LCM workload, determine, a LCM capability level for implementing the first workload, identify an LCM component capable of providing the LCM capability level, and transmit an implementation request to the LCM component to implement the first workload.

According to some embodiments there is provided a computer program comprising instructions which, when executed on at least one processor, cause the at least one processor to carry out the method as described above.

According to some embodiments there is provided a computer program product comprising a computer-readable medium with the computer program as described above.

### BRIEF DESCRIPTION OF THE DRAWINGS

For a better understanding of the present invention, and to show how it may be put into effect, reference will now be made, by way of example only, to the accompanying drawings, in which:

FIG. 1 illustrates an example of a virtualisation network 100 for implementing workloads;

FIG. 2 illustrates an example of a method, in a serverless life-cycle management, LCM, dispatcher, 102 for implementing a workload in a virtualization network;

FIG. 3 illustrates an example of a registration process for registering workloads in the workload description database;

FIG. 4 illustrates an example of the process of selecting an LCM analyser instance;

FIG. 5 illustrates an example where the first workload comprises a non LCM workload capable of being implemented in the virtual network with no LCM routines;

FIG. 6 illustrates an example where the first workload comprises an LCM workload capable of being implemented using LCM routines;

FIG. 7 illustrates an example where the first workload comprises an LCM workload capable of being implemented using LCM routines;

FIG. 8 illustrates an example where no LCM components are available;

FIG. 9 illustrates an example of a serverless LCM dispatcher according to some embodiments;

FIG. 10 illustrates an example of a serverless LCM dispatcher according to some embodiments.

### DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

In some embodiments, FaaS frameworks are utilized to manage resource lifecycle management (LCM) by prioritizing and dispatching received workload requests to appropriate lifecycle management routines depending on a complexity level of the workload to be implemented. Dispatching functionality may be performed by a Serverless Lifecycle Management (LCM) Dispatcher. The serverless LCM dispatcher may be configured to receive workload triggers and to map them to the workload descriptions stored in a registration phase, and to process workload descriptions and analyse LCM dependencies in order to determine a complexity level of the workload. The level of LCM component required to implement the workload can then be determined and LCM requests can be dispatched to appropriate LCM components.

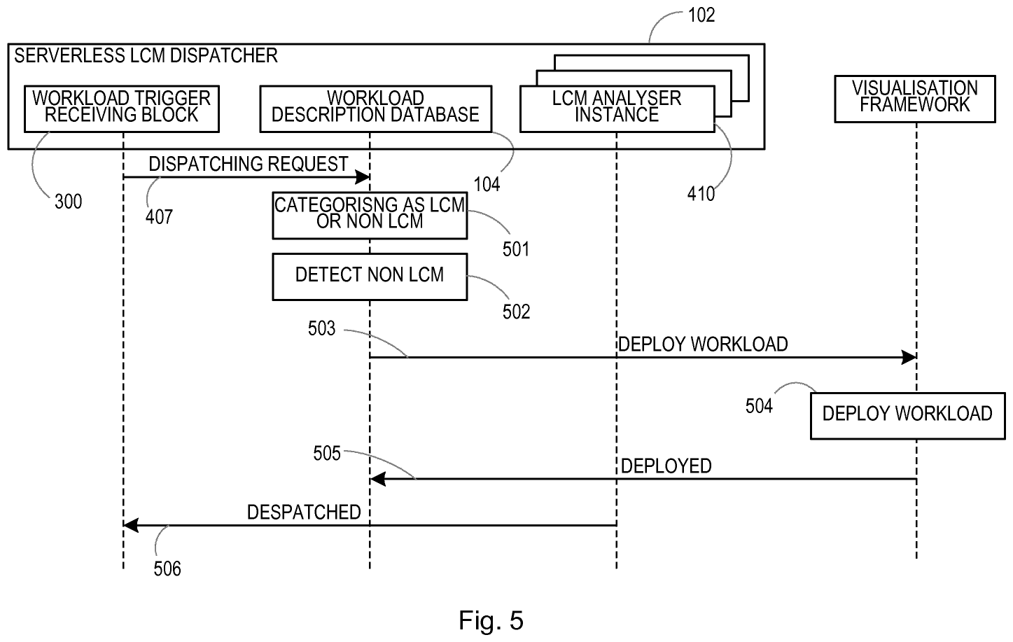

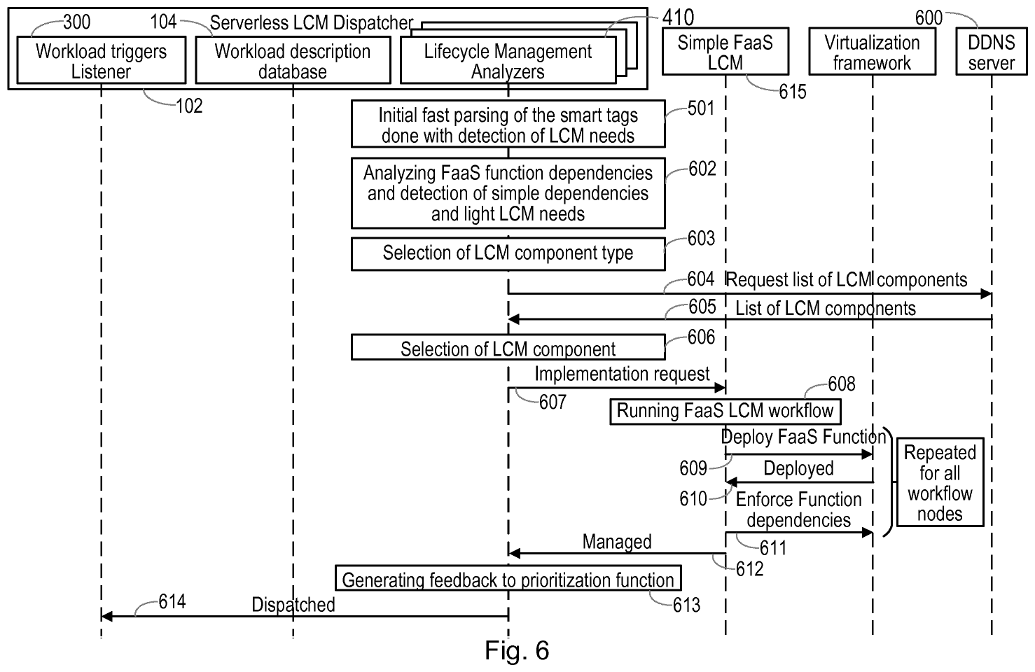

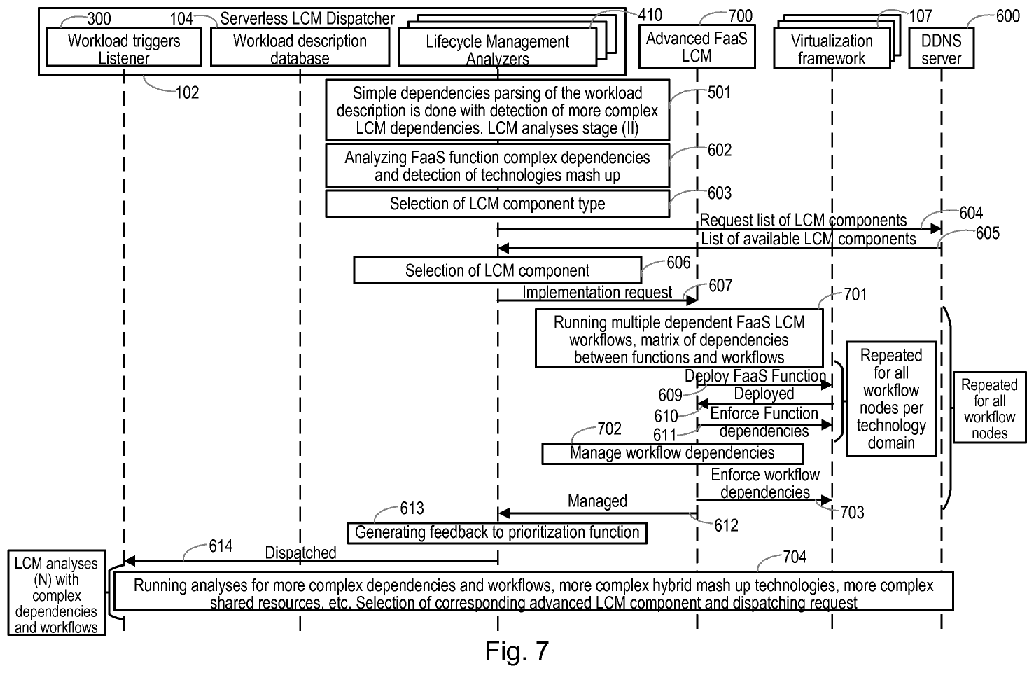

In embodiments described herein, a serverless LCM dispatcher is configured to allocate serverless LCM components per orchestration demand. In particular, simple function requests with limited dependencies and simple topologies are still seamlessly forwarded for the further processing to the native FaaS virtualization framework, as will be described in FIG. 5. However, more complex function requests with more advanced topologies and/or dependencies between functions are forwarded to an appropriate FaaS lifecycle management component, as will be described in FIGS. 6 and 7. Complex functions may comprise complex FaaS topologies and/or hybrid topologies where dependent non FaaS functions are used together. Hybrid topologies may comprise functions deployed in containers or virtual machines or even existing dependent shared functions. Functions with more advanced LCM routines may still use the native virtual framework of the serverless LCM dispatcher for individual function initiations.

Embodiments described herein are adaptive and enable a learning procedure where the dispatching process can feed feedback information to the internal prioritization function in runtime. Adaptive mechanisms may therefore granularly improve the dispatching process by updating registered workload priority information and workload request load balancing.

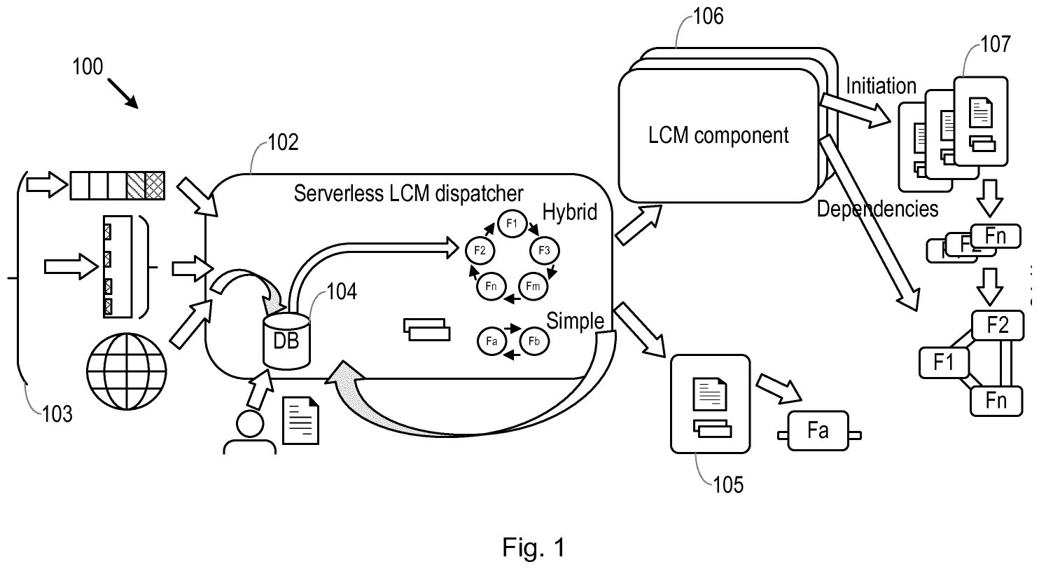

FIG. 1 illustrates an example of a virtualisation network 100 for implementing workloads. The virtualization network 100 comprises a serverless LCM dispatcher 102 configured to receive workload triggers 103. In this example, the serverless LCM dispatcher 102 comprises a FaaS registry 104 (also referred to as a workload description database). The FaaS registry 104 may be configured to store descriptions of workloads that the virtualisation network is capable of implementing. The descriptions may for example comprise triggering information, blueprints of the triggered workload describing, for example, the structure of executing virtual machines and/or containers, network and related dependencies of the virtual functions utilised to implement the workload, and/or results of analysis of the workload. The descriptions of the workloads may further comprise information relating to the configuration of workloads, the constraints of LCM routines, the topology of the network framework(s), workflows and any other LCM artifacts.

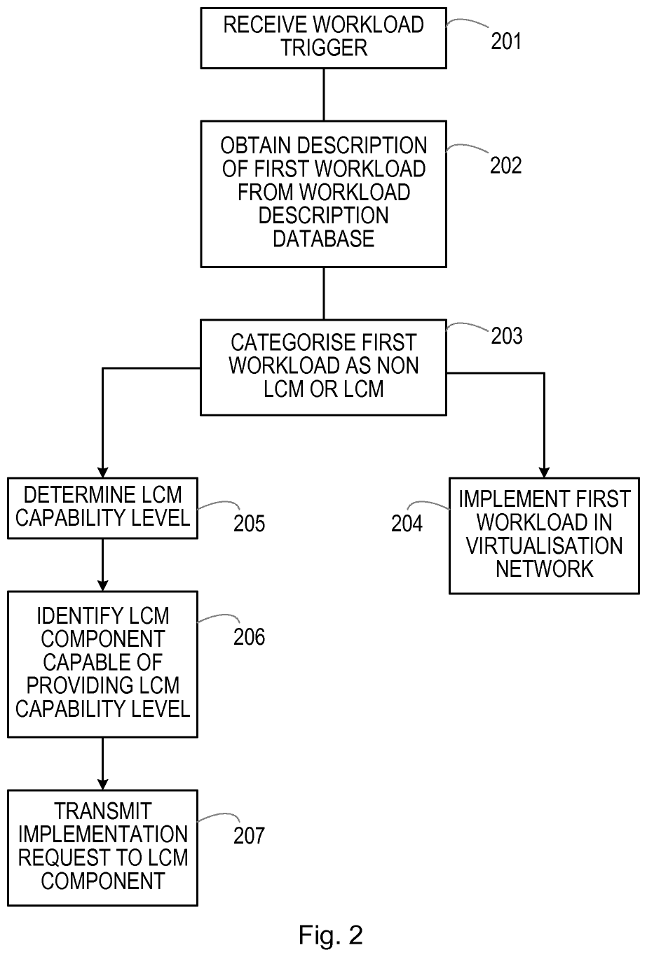

These descriptions of the workloads that the virtualisation network is capable of implementing may be stored in the FaaS registry 104 by registering new workloads in the FaaS registry 104. This process will be described in more detail later with reference to FIG. 2.

The workload triggers 103 may comprise one or more of: incoming messages a connection to a port-range, a received event on an event queue or an http request with a path bound to a FaaS or any other suitable triggering mechanism for triggering a workload in a virtualised network. In particular the workload triggers 103 may comprise an indication of a first workload to be implemented by the virtual network.

On receiving a workload trigger the serverless LCM dispatcher 102 may be configured to obtain a description of the first workload requested by the workload trigger from a workload description database 104. In other words, the received workload trigger 103 may be matched to the descriptions stored in the FaaS registry 104, and the matching description read from the FaaS registry 104.

The serverless LCM dispatcher 102 may then categorise based, on the description and the workload trigger 103, the first workload as a non LCM workload capable of being implemented with no LCM routines, or an LCM workload capable of being implemented using LCM routines.

For example, the serverless LCM dispatcher 102 may analyse the obtained description to determine the complexity of the triggered first workload. For example, the first workload may comprise a simple workload having for example low level hierarchy between virtual functions, or may comprise a complex hierarchy or hybrid functions. In some examples, simple workloads may be described as workloads which do not require LCM routines in order to be implemented in a virtual framework. In some examples, complex workloads may be described as workloads which do require some LCM routines in order to be implemented in one or more virtual frameworks.

If the first workload comprises a simple workload, the serverless LCM dispatcher 102 may implement the first workload in the virtualization network 100, for example, utilising its own native virtual framework 105.

If however, the first workload comprises a complex workload, the serverless LCM dispatcher 102 may determine an LCM capability level for implementing the first workload. For example, LCM capability levels may comprise a first level having simple LCM routines associated with a small hierarchy of dependencies for implementing a workload; and a second level having advanced LCM routines associated with a large hierarchy of dependencies for implementing a workload. It will be appreciated that many different levels of LCM capability may be used, and the delineation between these capabilities may be determined based on how the overall virtual network is required to function. As illustrated in FIG. 1, the serverless LCM dispatcher 102 then selects an appropriate LCM component 106 capable of implementing workloads of the appropriate complexity, and forwards the first workload to the selected LCM component 106.

The LCM component 106 may then analyse the description of the first workload to determine any LCM dependencies and workflows associated with the first workload. The LCM component 106 may then implement the first workload in one or more virtual frameworks 107. The virtual frameworks 107 may comprise the native virtual framework 105 of the serverless LCM dispatcher 102.

FIG. 2 illustrates an example of a method, in a serverless life-cycle management, LCM, dispatcher, 102 for implementing a first workload in a virtualization network. This example illustrated a single workload trigger requesting the implementation of a single workload. However, it will be appreciated that many workload triggers may be received requesting different workloads.

In step 201 the serverless LCM dispatcher receives a workload trigger comprising an indication of a first workload. For example, as illustrated in FIG. 1 this workload trigger may comprise a connection to a port-range, a received event on an event queue, an http request with a path bound to a Function as a Service, FaaS, or any other suitable workload trigger.

In step 202, the serverless LCM dispatcher obtains a description of the first workload from the workload description database 104.

In step 203, the serverless LCM dispatcher categorises, based on the description and the workload trigger, the first workload as a non LCM workload capable of being implemented with no LCM routines or an LCM workload capable of being implemented using LCM routines.

If in step 203, the serverless LCM dispatcher categorises the first workload as a non LCM workload, the method passes to step 204 in which, the LCM dispatcher implements the first workload in the virtualization network, for example in the native virtualization framework 105 associated with the serverless LCM dispatcher 102.

If in step 203, the serverless LCM dispatcher categorises the first workload as an LCM workload, the method passes to step 205 in which, the serverless LCM dispatcher determines an LCM capability level for implementing the first workload. The serverless LCM dispatcher may then be configured to determine an LCM capability level for implementing workloads. In some examples, the categorisation and determination of LCM capability levels may be performed by an LCM analyser instance within the serverless LCM dispatcher. Which LCM analyser instance is selected by the LCM dispatcher for a particular workload may depend, for example, on the load of each LCM analyser instance and the priority of the particular workload.

It will be appreciated that the specific blocks within the serverless LCM dispatcher may be implemented in any way which provides the method steps according to the embodiments disclosed herein.

In step 206, the serverless LCM dispatcher identifies an LCM component capable of providing the LCM capability level. In step 207, the serverless LCM dispatcher transmits an implementation request to the identified LCM component to implement the first workload. As illustrated in FIG. 1, the LCM component may analyse the description of the first workload to determine the dependencies and hierarchy of virtual functions required to implement the first workload. The LCM component may then implement the first workload in one or more virtual frameworks 107.

As previously described, the workload description database 104 comprises a database of workloads that the virtualization network, which comprises a plurality of virtual frameworks accessible through different LCM components, is capable of implementing.

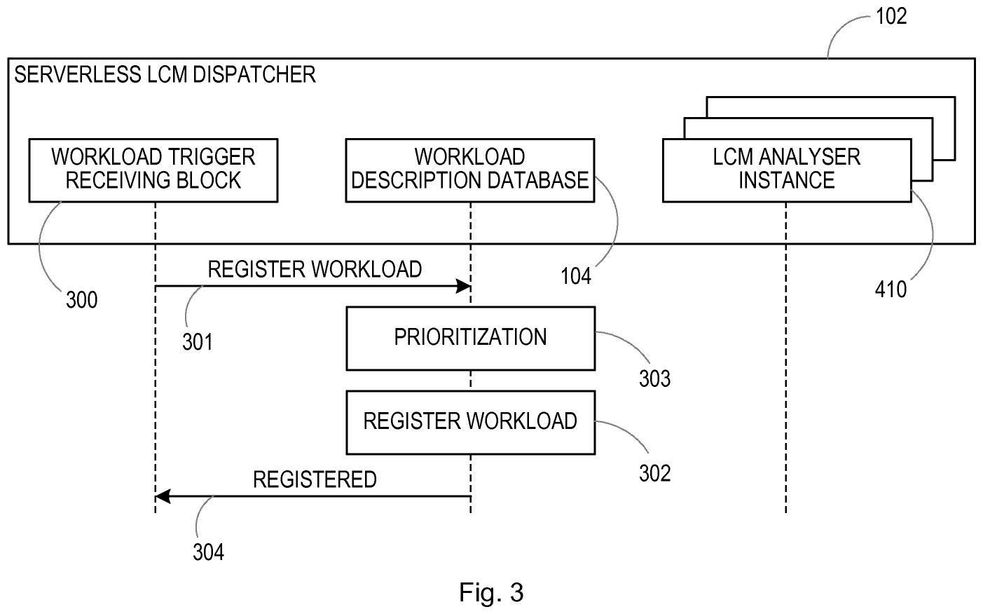

FIG. 3 illustrates an example of a registration process for registering workloads in the workload description database. The purpose of this process is to decrease the time needed for the final, execution time analysis, thus enabling the virtual network to respond faster to incoming requests.

The creation of a new workload may be triggered by different serverless function triggers. Workloads may be requested by the users of the virtual framework(s), for example, a request may be received to provide routing between points A and B in a network and, as this service may use serverless functions to do some routing processing and optimization, the user may request these functions via the serverless LCM dispatcher using defined triggers which may comprise desirable configurations and inputs.

The process illustrated in FIG. 3 may be triggered by an external entity, for example an admin entity, external provider or any other orchestration component which may be responsible for onboarding of any new workload types. For example a workload/workload-description designer may push a workload description to the serverless LCM dispatcher once it has been validated in some sandbox or pre deployment validation testbed. The new workload may also be related to a new type of dispatching workload trigger where new or customized workloads supporting such a request may be onboarded to the serverless LCM dispatcher.

In step 301, a workload trigger receiving block 300 initiates the registration of a workload in the workload description database 104. For example, the workload may comprise a FaaS which the virtual network is now capable of implementing. In some examples, the blueprint of the workload will be analysed on registration and the description of the workload may be stored in the workload description database 104 in step 302. In other words the trigger is analysed to determine a description of the workload and then stored in the workload description database 104. As previously mentioned, it will be appreciated that the description of the workload may comprise information relating one or more of: a workload trigger (for example smart tags associated with the workload), virtual machines or containers associated with the first workload, network related dependencies of the first workload, a configuration if the first workload, constraints of the first workload, a topology of the first workload and workflows of the first workload.

The description of the workload may also comprise priority information associated with the workload. In other words, the workload description database 104 may also contain information about LCM analyser instance groupings and priorities of the workloads. In some examples, the workload may be assigned a priority level in step 303 based on the LCM capability level required to implement it. In some examples, the description of the workload may isolate LCM analyser instances 410 that have specific resources. For instance, the description of the workload may contain information indicating that requests for the workload which are received from a particular customer are to be directed to a specific isolated group of one or more LCM analyser instances 410 in the serverless LCM dispatcher 102.

The workload description database 104 may then indicate to the workload trigger receiving block that the workload has been registered, in step 304.

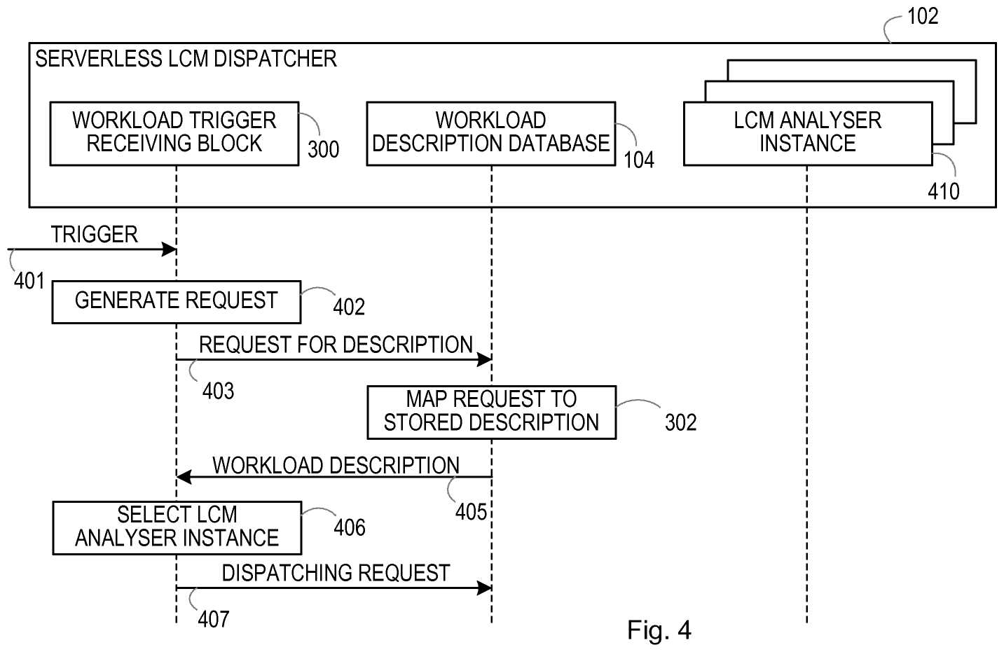

FIG. 4 illustrates an example of the process of selecting an LCM analyser instance. In step 401, the serverless LCM dispatcher 102, in particular the workload trigger receiving block 300 receives a workload trigger 401. The workload trigger 401 comprises an indication of the first workload. For example, a smart tag which is associated with the description the first workload during the registration process.

On receipt of the workload trigger, the serverless LCM dispatcher 102 obtains the description of the first workload from the workload description database 104. In the examples described herein, the workload description database 104 forms part of the serverless LCM dispatcher. However, it will be appreciated that in some embodiments, the workload description database may be part of some other virtual node.

In the example illustrated in FIG. 4, the serverless LCM dispatcher 102 obtains the description of the first workload by performing the following steps. First, the workload trigger receiving block generates, in step 402, a request for a description based on the workload trigger received in step 401. In step 403 the workload trigger receiving block 300 then forwards the request for the description to the workload description database 104.

In step 404, the workload description database 104 maps the received request, which may comprise smart tags associated with at least one description stored in the workload description database 104, to at least one description stored in the workload description database 104. In other words, the blueprint, analysis information, priority information and any other information in the description of the first workload may be read from the workload description database 104 in step 404 and transmitted to the workload trigger receiving block 300 in step 405.

In some embodiments, in step 406 the serverless LCM dispatcher 102, in this example the workload trigger receiving block 300, may select an LCM analyser instance from the available LCM analyser instances 410 based on the description of the first workload and/or the received workload trigger. In some embodiments, where priority information in the description of the first workload suggests a higher priority than the available LCM analyser instances in the serverless LCM dispatcher are able to provide, the serverless LCM dispatcher may create a new LCM analyser instance.

In step 407 the serverless LCM dispatcher (in this example, the workload trigger receiving block) transmits a dispatching request to a selected LCM analyser instance 410 to analyse and implement the first workload. The dispatching request 407 may comprise the description of the first workload, for example the blueprint and priority information associated with the first workload. The dispatching request may also comprise workload trigger inputs along with the description of the first workload. It will be appreciated that descriptions of workloads may comprise different levels of information, from simple smart tags to more complex information on required resources, relationships, constraints and other LCM dependencies.

The selection of an LCM analyser instance 410 may, in some examples, be based on the priority information associated with the first workload. For example, high priority cases may be forwarded to an LCM analyser instance 410 which has enough capacity and low enough load to handle request quickly. In some examples, the selection of the LCM analyser instance 410 may be based on an estimated processing latency of the first workload. In other words, similar workloads may be sent to the same LCM analyser instance, as the processing latency may be reduced.

As previously mentioned, priority information relating to the each workload may be determined and analysed in the registration phase, and stored in the workload description database 104 as part of the description of the respective workload. However, in some examples, the workload trigger may contain information regarding the priority that should be applied to this particular instance of the workload.

For example, the description of the first workload may comprise a first indication indicating whether the first workload is an LCM workload or a non LCM workload. This first indication may also indicate a priority level associated with the first workload. For example, some LCM workloads may be accounted a higher priority level than other LCM workloads.

In some embodiments the workload trigger comprises a second indication indicating whether the first workload is an LCM workload or a non LCM workload. This second indication may also comprise an indication of the priority associated with this particular request for the workload.

In some embodiments, therefore the second indication in the workload trigger overrides the first indication in the description of the first workload. In other words, the information stored in the workload description database regarding the priority information associated with a particular workload, may, in some embodiments be changed or overridden by a workload trigger which indicates that the priority assigned to the particular instance of the requested workload is different to that indicated by the stored description of the workload.

Once the selected LCM analyser has received the dispatching request, the LCM analyser instance may categorise, as described in step 203 of FIG. 2, based on the description and the workload trigger, the first workload as a non LCM workload capable of being implemented with no LCM routines, or an LCM workload capable of being implemented using LCM routines.

FIG. 5 illustrates an example where the first workload comprises a non LCM workload capable of being implemented in the virtual network with no LCM routines. In this example, in step 501 the LCM analyser instance 410 analyses the description of the first workload received in step 407.

In this example, the first workload is a non LCM workload, so the analysis of the description of the first workload leads the LCM analyser instance 410 to detect, in step 502 that the first workload does not require any LCM routines in order to implement the workload in the virtualisation network. The LCM analyser instance 410 then, in response to categorising the first workload as a non LCM workload in step 502, implements the first workload in the virtualization network. In this example, the LCM analyser instance 410 implements the first workload by transmitting a request 503 to a native virtualisation framework 105, associated with the serverless LCM dispatcher 102, to implement the first workload. The request 503 may comprise the description of the first workload and may provide enough information to allow the native virtualisation framework to deploy the first workload in step 504.

The virtual framework 105 may then indicate to the serverless LCM dispatcher 102, in step 505, that the first workload has been deployed. The LCM analyser instance 410 may then indicate to the workload trigger receiving block 300 than the first workload has been successfully deployed in step 506.

In this way therefore, the LCM analyser instance 410 prioritizes workloads having shortest processing paths for with minimal latency and no LCM routines. Simple workloads without advanced dependencies or topology may therefore be directly transmitted to the native virtualization framework (e.g. FaaS) where the function may be eventually initiated.

FIG. 6 illustrates an example where the first workload comprises an LCM workload capable of being implemented using LCM routines.

In step 501, similarly to as described in FIG. 5, the LCM analyser instance 410 categorises the first workload as a non LCM workload capable of being implemented with no LCM routines, or an LCM workload capable of being implemented using LCM routines.

In particular, this first stage of analysis which categorises the first workload as an LCM workload or a non LCM workload allows the analysis of the first workload to be taken in incremental steps. This initial step comprises faster and simpler checks before moving to more complex checks relating to dependencies and LCM complexity. As previously illustrated, for workloads which are non LCM workloads with no dependencies, this first categorisation step is configured filter out the non LCM workloads so that they may be immediately forwarded to the virtualization framework without need for further LCM routines.

In step 501 therefore, the LCM analyser instance 410 may check just simple smart tags or constraints in the workload description to detect a simple and plane workload, i.e. a non LCM workload.

As in this example, the first workload comprises an LCM workload, the LCM analyser categorises the first workload as an LCM workload and performs step 602 instead of simply implementing the first workload as illustrated in FIG. 5.

In step 602 further analysis of the first workload is performed. For example, the LCM analyser instance 410 may analyse the description of the first workload in order to determine an LCM capability level suitable for the instantiation and deployment phase. There may be a plurality of different LCM capability levels, for example a first level comprising simple LCM routines associated with a small hierarchy of dependencies for implementing a workload; and a second level comprising advanced LCM routines associated with a large hierarchy of dependencies for implementing a workload.

In this example, the first workload is of the first LCM capability level. In step 602 therefore, the LCM analyser instance 410 analyses the description of the first workload. for example, analysing the topology or/and dependencies between the functions. From this analysis, the LCM analyser instance 410 can deduce that the first level of LCM capability is sufficient for implementing the first workload, and therefore selects the first level of LCM capability in step 603.

In this example, therefore, the serverless LCM dispatcher 102 identifies an LCM component 615 capable of providing the selected LCM capability level which, in this example, is the first level. To identify an LCM component 615 capable of providing the first LCM capability level the LCM analyser instance 410 may transmit a request 604 to an LCM database 600 (e.g. a DDNS server) for a list of LCM components capable of providing the first LCM capability level.

The LCM database 600, may then transmit 605 a list of LCM components to the LCM analyser instance, wherein each LCM component in the list is capable of providing the first LCM capability level.

In step 606 the LCM analyser instance may then select an LCM component 615 from the list of LCM components. The selected LCM component 615 may be specialized for a type of functionality and related technology for the first workload. It may be also much faster in providing LCM routines than a more complex LCM component supporting a wider range of functionality.

In step 607 the LCM analyser instance 410 then transmits an implementation request to the selected LCM component 615 to implement the first workload.

In response to receiving the implementation request 607, the LCM component 615 may run a FaaS LCM workflow 608 to manage requested LCM dependencies and interactions with virtualization framework driven by LCM workflows. The LCM component 615 may then deploy the first workload in steps 609 to 611 in the virtualisation framework 105.

In particular, the LCM component 615 may deploy an FaaS function required to implement the first workload in the virtual framework in step 609. In step 610 the virtual framework acknowledges that the FaaS function has been deployed and in step 611, the LCM component 615 enforces any dependencies of that FaaS function on other functions. The steps 609 to 611 may then be repeated for each function required to implement the first workload.

In step 612 the LCM component 615 may then confirm to the LCM analyser instance 410 that the first workload has been implemented in the virtual network.

In step 613 the LCM analyser instance 410 may generate feedback based on the confirmation from the LCM component 615 relating the implementation of the first workload. For example, the feedback may comprise information regarding the availability of dependent resources, available resources and/or preferred resource pools. The feedback may also comprise information relating to a time taken to implement the first workload.

The feedback information may then be used by the LCM analyser instance 410 to update the description of the first workload in the workload description database 104. For instance the blueprint and input data for the analyser instance may be updated to reflect the resources that are already available in the virtual network. In particular, the feedback information may be used to adjust the priority of the first workload based on the received feedback.

In some examples, if the time taken to actually implement a workload is longer than expected, then the priority of the workload may be increased in the workload description database in order to account for the unexpected latency.

In step 614 the LCM analyser instance 410 confirms to the workload trigger receiving block 300 that the first workload has been dispatched.

FIG. 7 illustrates an example where the first workload comprises an LCM workload capable of being implemented using LCM routines.

Many of the steps illustrated in this figure are similar to the steps illustrated in FIG. 6, and have therefore been given similar reference numerals.

In this example, the first workload comprises an LCM workload with complex LCM requirements. In particular, the first workload in this example requires the second LCM capability level comprising advanced LCM routines associated with a large hierarchy of dependencies for implementing a workload. In this example, the second LCM capability level may be associated with a requirement to implement a workload over multiple technologies using a plurality of virtual frameworks.

In step 501, as described previously, the LCM analyser instance 410 categorises the first workload as a non LCM workload capable of being implemented with no LCM routines, or an LCM workload capable of being implemented using LCM routines.

As, in this example, the first workload comprises an LCM workload, the LCM analyser instance 410 categorises the first workload as an LCM workload and performs step 602 instead of simply implementing the first workload as illustrated in FIG. 5.

Similarly to as described with reference to FIG. 6, in step 602 further analysis of the first workload is performed. For example, the LCM analyser instance 410 may analyse the description of the first workload in order to determine an LCM capability level suitable for the instantiation and deployment phase.

In this example, the first workload is of the second LCM capability level. In step 602 therefore, the LCM analyser instance 410 analyses the description of the first workload, for example, analysing the topology or/and dependencies between the functions. From this analysis, the LCM analyser instance 410 deduces that the second level of LCM capability is required for implementing the first workload, and therefore the LCM analyser instance 410 selects the second level of LCM capability in step 603.

In this example, therefore, the serverless LCM dispatcher 102 identifies an LCM component 700 capable of providing the selected LCM capability level which, in this example, is the second level. To identify an LCM component 700 capable of providing the second LCM capability level, the LCM analyser instance 410 may transmit a request 604 to an LCM database (e.g. a DDNS server 600) for a list of LCM components capable of providing the second LCM capability level.

The LCM database 600, may then transmit 605 a list of LCM components to the LCM analyser instance 410, wherein each LCM component in the list is capable of providing the second LCM capability level.

In step 606 the LCM analyser instance 410 may then select an LCM component 700 from the list of LCM components.

In step 607 the LCM analyser instance 410 then transmits an implementation request to the selected LCM component 700 to implement the first workload.

In response to receiving the implementation request 607, the LCM component 700 may run a multiple dependent FaaS LCM workflows 701 to manage requested LCM dependencies and interactions of functions within each of the multiple virtualization frameworks driven by the LCM workflows. The LCM component may then deploys the first workload in steps 609 to 703 in the multiple virtualisation frameworks 107.

In particular, the LCM component 700 may deploy one of the FaaS functions required to implement the first workload in the virtual framework in step 609. In step 610 the virtual framework acknowledges that the FaaS function has been deployed and in step 611, the LCM component 700 enforces the dependencies of that FaaS function on other functions within the same virtual framework. The steps 609 to 611 may then be repeated for each function required to implement the first workload.

The steps 609 to 611 may then be repeated until all of the functions required are deployed in all of the virtual frameworks 107.

In step 702 the LCM component 700 may then manage the dependencies between the workflows in the different virtual frameworks 107, and may enforce the workflow dependencies in step 703.

In step 612 the LCM component 700 may then confirm to the LCM analyser instance 410 than the first workload has been implemented in the virtual network.

In step 613 the LCM analyser instance 410 may then generate feedback based on the confirmation from the LCM component 700 relating the implementation of the first workload. For example, the feedback may comprise information regarding the availability of dependent resources, available resources and/or preferred resource pools. The feedback may also comprise information relating to a time taken to implement the first workload.

The feedback information may then be used by the LCM analyser instance 410 to update the description of the first workload in the workload description database 104. For instance the blueprint and input data for the analyser instance may be updated to reflect the resources that are already available in the virtual network. In particular, the feedback information may be used to adjust the priority of the first workload based on the received feedback.

In this way, the serverless LCM dispatcher may improve the process of implementing the same or similar workloads in the future, as it gains knowledge regarding the time taken to implement the workloads and/or the functions already available in particular virtual frameworks. Therefore, rather than deploying the same function again in a different virtual framework, the LCM analyser instance 410 may select the same LCM component to implement the same workload a second time around.

In step 614 the LCM analyser instance 410 confirms to the workload trigger receiving block 300 that the first workload has been dispatched.

When, as illustrated in FIG. 7, a workload combines multiple virtualization technologies or/and existing resources sharing, the workload may be directed to a more advanced hybrid LCM component which is capable of handling multiple technology domains, more advanced hybrid functions and more advanced workflows in order to realize the requested more complex dependencies and functionality.

It will be appreciated than in the examples given there are two layers of analysis performed by the LCM analyser, one to filter out workloads requiring no LCM routines, and one to distinguish between simple LCM routines and advanced LCM routines. However, it will be appreciated that this iterative process may be continued to differentiate in following analysis stages between advance LCM routines and highly advanced LCM routines, and so on. Every next step of analysis may indicate even more advanced LCM routines and may trigger dispatching to a corresponding more advanced LCM component.

In some embodiments, there may be multiple LCM analyser instances 410 in the LCM dispatcher component 102 serving parallel dispatching requests depending on the load and prioritization. Workload load balancing across LCM analyser instances 410 may follow preferable dispatching model. Different levels of workload prioritization may also be indicated in workload description or initial inputs. For instance, all highly prioritized workloads may be sent to a separate LCM analyser instance 410 from those needing higher levels of processing or having lower priority.

In some cases, the workload trigger receiving block 300 may determine that the first workload requires a level of service from an LCM analyser instance 410 which the available analyser instances are not capable of providing. In these circumstances, the workload trigger receiving block may instantiate a new LCM analyser instance 410 by using an LCM dispatching process or by using an external entity.

The LCM analyser instance may be capable of understanding all types of descriptions of workloads, and therefore some common information model may be used. In some examples therefore, the descriptions of the workloads are generalised and templates are used to simplify the analysis and enables a more efficient and accurate analysis of the different workloads. Furthermore, the templates may be reusable for multiple workload types and related services. For example, the same type of workload may use the same description for different users, but with different configurations and data input to distinguish between the different users.

In some embodiments, there may be an initial number of LCM components pre-allocated to support initial LCM requests dispatched by an LCM analyser instance 410. In order to optimize resource usage LCM components may be released when they are not used and the new instances may be allocated again per LCM processing load demand.

Therefore, in some embodiments, an LCM analyser instance 410 may transmit a request to an LCM database for a list of LCM components capable of providing the determined LCM capability level and receive a response indicating that no LCM components are available.

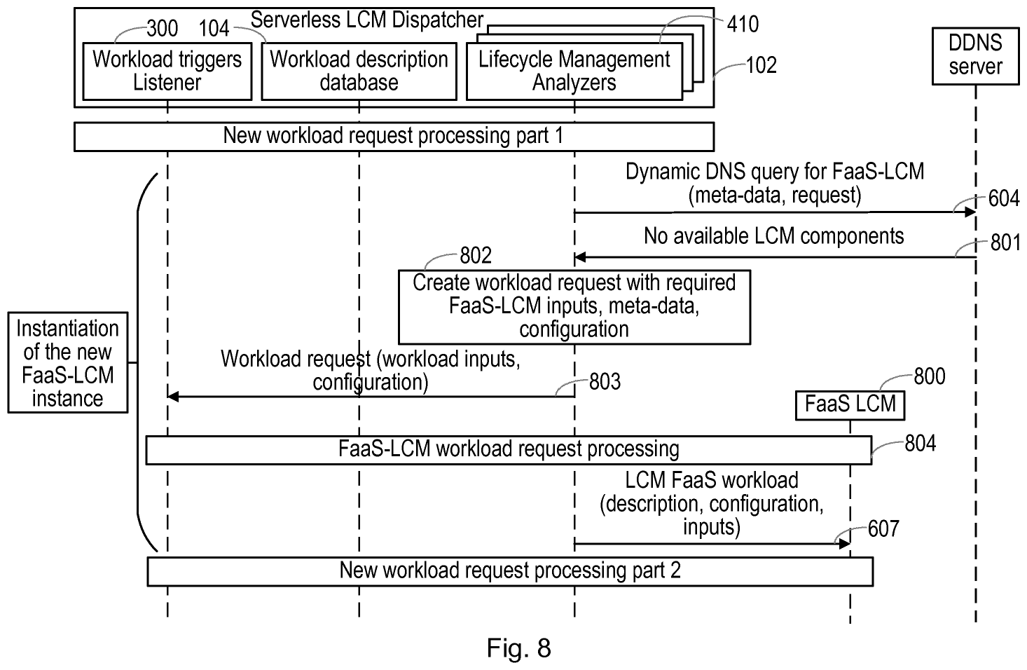

FIG. 8 illustrates an example where no LCM components are available.

In this example, in response to transmitting the request 604 to an LCM database (e.g. a DDNS server 600) for a list of LCM components capable of providing the selected LCM capability level, the LCM analyser instance 410 receives a response 801 indicating that no LCM components are available.

The LCM analyser instance 410 may therefore create 802 and place 803 a new workload request for a new LCM component to the workload trigger receiving block 300. The generation of the new LCM component 800 may then be prioritized, and instantiation 804 of the new LCM component 800 or a new dispatcher component may use some acceleration technique such as preheated containers to limit latency.

Once the LCM component 800 has been created, the LCM analyser instance 410 may transmit 607 the request to implement the first workload to the LCM component 800, as previously described.

By utilising the above methods and apparatus and in particular by incrementally analysing the description of the workloads in an LCM analyser instance, the serverless LCM dispatcher may serve seamlessly different virtualization frameworks, such as FaaS framework, but also any other orchestration framework where such functionality is needed. Furthermore, this is enables without having to perform extensive analysis on simple workloads which would not be needed in order to successfully implement the workload. This solution enables seamless usage of multiple virtualization frameworks in the serverless virtualization framework. It also enables mash-up hybrid functions such as FaaS functions with non FaaS functions as well as mashup with shared functions by using different virtual frameworks and technologies.

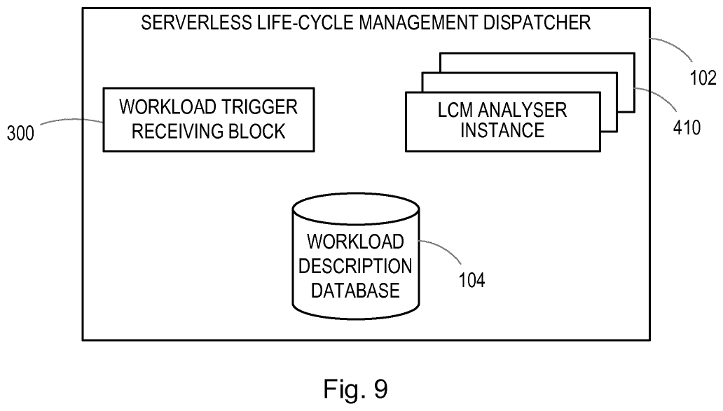

FIG. 9 illustrates a serverless LCM dispatcher 102 according to some embodiments. The serverless LCM dispatcher in this example comprises a workload trigger receiving block 104, a workload description database 104 and at least one LCM analyser instance 410.

The workload trigger receiving block 104 is configured to receive a workload trigger comprising an indication of a first workload.

The workload trigger receiving block 104 is also configured to obtain a description of the first workload from a workload description database based on the indication of the first workload.

The LCM analyser instance 410 is the configured to categorise, based on the description and the workload trigger, the first workload as a non LCM workload capable of being implemented with no LCM routines, or an LCM workload capable of being implemented using LCM routines; and responsive to categorising the first workload as an LCM workload, determine, in a first LCM analyser instance, a LCM capability level for implementing the first workload, identifying an LCM component capable of providing the LCM capability level; and transmitting a implementation request to the LCM component to implement the first workload.

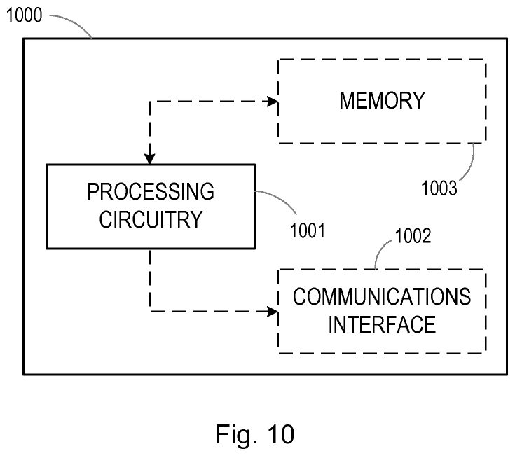

FIG. 10 illustrates a serverless LCM dispatcher 1000 according to some embodiments comprising processing circuitry (or logic) 1001. The processing circuitry 1001 controls the operation of the serverless LCM dispatcher 1000 and can implement the method described herein in relation to a serverless LCM dispatcher 1000. The processing circuitry 1001 can comprise one or more processors, processing units, multi-core processors or modules that are configured or programmed to control the serverless LCM dispatcher 1000 in the manner described herein. In particular implementations, the processing circuitry 1001 can comprise a plurality of software and/or hardware modules that are each configured to perform, or are for performing, individual or multiple steps of the method described herein in relation to the serverless LCM dispatcher 1000.

Briefly, the processing circuitry 1001 of the serverless LCM dispatcher 1000 is configured to: receive a workload trigger comprising an indication of a first workload, obtain a description of the first workload from a workload description database based on the indication of the first workload; categorise, based on the description and the workload trigger, the first workload as a non LCM workload capable of being implemented with no LCM routines, or an LCM workload capable of being implemented using LCM routines; and responsive to categorising the first workload as an LCM workload, determine, a LCM capability level for implementing the first workload, identify an LCM component capable of providing the LCM capability level; and transmit an implementation request to the LCM component to implement the first workload.

In some embodiments, the serverless LCM dispatcher 1000 may optionally comprise a communications interface 1002. The communications interface 1002 of the serverless LCM dispatcher 1000 can be for use in communicating with other nodes, such as other virtual nodes. For example, the communications interface 1002 of the serverless LCM dispatcher 1000 can be configured to transmit to and/or receive from other nodes requests, resources, information, data, signals, or similar. The processing circuitry 1001 of the serverless LCM dispatcher 1000 may be configured to control the communications interface 1002 of the serverless LCM dispatcher 1000 to transmit to and/or receive from other nodes requests, resources, information, data, signals, or similar.

Optionally, the serverless LCM dispatcher 1000 may comprise a memory 1003. In some embodiments, the memory 1003 of the serverless LCM dispatcher 1000 can be configured to store program code that can be executed by the processing circuitry 1001 of the serverless LCM dispatcher 1000 to perform the method described herein in relation to the serverless LCM dispatcher 1000. Alternatively or in addition, the memory 1003 of the serverless LCM dispatcher 1000, can be configured to store any requests, resources, information, data, signals, or similar that are described herein. The processing circuitry 1001 of the serverless LCM dispatcher 1000 may be configured to control the memory 1003 of the serverless LCM dispatcher 1000 to store any requests, resources, information, data, signals, or similar that are described herein.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method, in a serverless life-cycle management (LCM) dispatcher, for implementing a workload in a virtualization network, the method comprising:
receiving a workload trigger comprising an indication of a first workload;
obtaining a description of the first workload from a workload description database based on the indication of the first workload;
categorising, based on the description and the workload trigger, the first workload as a non LCM workload capable of being implemented with no LCM routines, or an LCM workload capable of being implemented using LCM routines; and
responsive to categorising the first workload as an LCM workload,
determining, a LCM capability level for implementing the first workload,
identifying an LCM component capable of providing the LCM capability level, and
transmitting an implementation request to the LCM component to implement the first workload.

2. (canceled)

3. The method as claimed in claim 1, wherein the identifying comprises:
transmitting a request to an LCM database for a list of LCM components capable of providing the determined LCM capability level;
receiving the list of LCM components; and
selecting the LCM component from the list of LCM components.

4-5. (canceled)

6. The method as claimed in claim 1, wherein the description of the first workload comprises one or more of: virtual machines or containers associated with the first workload, network related dependencies of the first workload, a configuration of the first workload, constraints of the first workload, a topology of the first workload and workflows of the first workload, and serverless functions.

7. The method as claimed in claim 1, wherein the LCM capability level comprises a plurality of capability levels and wherein the capability levels comprise:
a first level comprising simple LCM routines associated with a small hierarchy of dependencies for implementing a workload; and
a second level comprising advanced LCM routines associated with a large hierarchy of dependencies for implementing a workload.

8. The method as claimed in claim 1, wherein the description of the first workload comprises a first indication indicating whether the first workload is an LCM workload or a non LCM workload.

9. The method as claimed in claim 8, wherein the workload trigger comprises a second indication indicating whether the first workload is an LCM workload or a non LCM workload.

10. (canceled)

11. The method as claimed in claim 9 further comprising:
performing the categorising, determining, identifying and transmitting in a first LCM analyser instance in the serverless LCM dispatcher; and
selecting the first LCM analyser instance from a plurality of LCM analyser instances based on the second indication or the first indication.

12. The method as claimed in claim 1, wherein the workload trigger comprises one or more of: an incoming message, a connection to a port-range, a received event on an event queue, and an http request with a path bound to a Function as a Service (FaaS).

13. The method as claimed in claim 1, wherein the description comprises priority information associated with the first workload, and wherein the method further comprises:
receiving feedback associated with the implementation of the first workload; and
adjusting the priority of the first workload based on the received feedback.

14. (canceled)

15. A serverless life-cycle management (LCM) dispatcher for implementing a workload in a virtualization network, the serverless LCM dispatcher comprising:
processing circuitry; and
a memory containing program code which, when executed on the processing circuitry, cause the serverless LCM dispatcher to:
receive a workload trigger comprising an indication of a first workload and obtain a description of the first workload from a workload description database based on the indication of the first workload;
categorise, based on the description and the workload trigger, the first workload as a non LCM workload capable of being implemented with no LCM routines, or an LCM workload capable of being implemented using LCM routines; and
responsive to categorising the first workload as an LCM workload, determine, a LCM capability level for implementing the first workload, identify an LCM component capable of providing the LCM capability level, and transmit an implementation request to the LCM component to implement the first workload.

16. (canceled)

17. The serverless LCM dispatcher as claimed in claim 15, further configured to identify the LCM component by:
transmitting a request to an LCM database for a list of LCM components capable of providing the determined LCM capability level;
receiving the list of LCM components; and
selecting the LCM component from the list of LCM components.

18-19. (canceled)

20. The serverless LCM dispatcher as claimed in claim 15, wherein the description of the first workload comprises one or more of: virtual machines or containers associated with the first workload, network related dependencies of the first workload, a configuration of the first workload, constraints of the first workload, a topology of the first workload and workflows of the first workload, and serverless functions.

21. The serverless LCM dispatcher as claimed in claim 15, wherein the LCM capability level comprises a plurality of capability levels and wherein the capability levels comprise:
a first level comprising simple LCM routines associated with a small hierarchy of dependencies for implementing a workload; and
a second level comprising advanced LCM routines associated with a large hierarchy of dependencies for implementing a workload.

22. The serverless LCM dispatcher as claimed in claim 15, wherein the description of the first workload comprises a first indication indicating whether the first workload is an LCM workload or a non LCM workload.

23. The serverless LCM dispatcher as claimed in claim 22, wherein the workload trigger comprises a second indication indicating whether the first workload is an LCM workload or a non LCM workload.

24. The serverless LCM dispatcher as claimed in claim 23, wherein the second indication in the workload trigger overrides the first indication in the description of the first workload.

25. The serverless LCM dispatcher as claimed in claim 23, wherein the workload trigger receiving block is further configured to select an LCM analyser instance to perform the categorising, determining, identifying and transmitting from a plurality of LCM analyser instances based on the second indication or the first indication.

26. The serverless LCM dispatcher as claimed in claim 15, wherein the workload trigger comprises one or more of: an incoming message, a connection to a port-range, a received event on an event queue, and an http request with a path bound to a Function as a Service (FaaS).

27. The serverless LCM dispatcher as claimed in claim 15, wherein the description comprises priority information associated with the first workload, and wherein the serverless LCM dispatcher is further configured to receive feedback associated with the implementation of the first workload and adjust the priority of the first workload based on the received feedback.

28. (canceled)

29. A non-transitory computer-readable storage medium comprising instructions which, when executed on at least one processor, are capable of causing a serverless life-cycle management (LCM) dispatcher, for implementing a workload in a virtualization network, to perform operations comprising:
receiving a workload trigger comprising an indication of a first workload;
obtaining a description of the first workload from a workload description database based on the indication of the first workload;
categorising, based on the description and the workload trigger, the first workload as a non LCM workload capable of being implemented with no LCM routines, or an LCM workload capable of being implemented using LCM routines; and
responsive to categorising the first workload as an LCM workload,
determining, a LCM capability level for implementing the first workload,
identifying an LCM component capable of providing the LCM capability level, and
transmitting an implementation request to the LCM component to implement the first workload.

30. (canceled)
